(19) United States
(12) Patent Application Publication
(10) Pub. No.: US 2008/0157484 A1
(43) Pub. Date: Jul. 3, 2008

(54) Multilobed Socket For Protection of a Vehicle Transmission

(75) Inventor: Cyrille Briton, Orvault (FR)

Correspondence Address: YOUNG & THOMPSON, 209 Madison Street, Suite 500, ALEXANDRIA, VA, 22314, US

(73) Assignee: Trelleborg Prodyn, Carquefou (FR)

(21) Appl. No.: 11/792,716

(22) PCT Filed: Dec. 7, 2005
(86) PCT No.: PCT/FR2005/003065

§ 371 Date: Jun. 11, 2007

(30) Foreign Application Priority Data
Dec. 15, 2004 (FR) 03/13333

(51) Int. Cl. F16J 3/04; F16D 3/10

(52) U.S. Cl. 277/636; 464/52

(57) ABSTRACT

The invention relates to a multilobed socket (5) for protection of a vehicle transmission between a drive shaft and a transmission bell, whereby said socket (5) comes in the form of a cylindrical-conical bellows (8) that extends between the large multilobed base (6) and the small base (7) of the socket (5).

This socket is characterized in that it has a new type of architecture close to the large multilobed base (6) of said socket (5), whereby this architecture consists in eliminating, in the pressure area zone of the socket (5) on the bell, any means of axial immobilization in said pressure area for the purpose of allowing free translation of the socket (5) in the direction of slippage, whereby a tightening collar is provided on the external face of said pressure area to exert a radial pressure for immobilization of the socket (5) against the receiving bell, whereby this radial pressure causes, to the right of the collar, a reduction of the thickness of the pressure area zone.

This invention relates to a multilobed socket for protection of a vehicle transmission between a drive shaft and a transmission bell as well as a transmission joint that is equipped for its sealing of such a socket.

In vehicles, between the transmission and the wheels of the vehicle, a transmission that consists of two shafts connected to one another via a mechanical transmission element that requires lubrication is provided. In general, the shaft that comes from the transmission is equipped with a bell that constitutes the female element of the transmission element that connects this first shaft to the second drive shaft. This female element assumes the shape of a generally trilobed cavity. The lobes thus delimit housings that are each designed to accommodate, for example, a roller. In this case, this roller is carried by a male element that has three roller bearings. This male element is itself coupled to the drive shaft. A protective socket of such a homokinetic tripodal joint of the type that is described above comprises a cylindrical-conical bellows that, at one end, comprises a large multilobed base that, in the mounted state, is applied to the external face of the bell or bowl of the joint. This large base therefore has an inside surface that has a shape that is complementary to the external shape of the multilobed bell. In the mounted state of the socket on said bell, a ring or collar tightens the large base against the periphery of the bell. The small base of the socket is attached to the drive shaft that is integral with the male element of the joint.

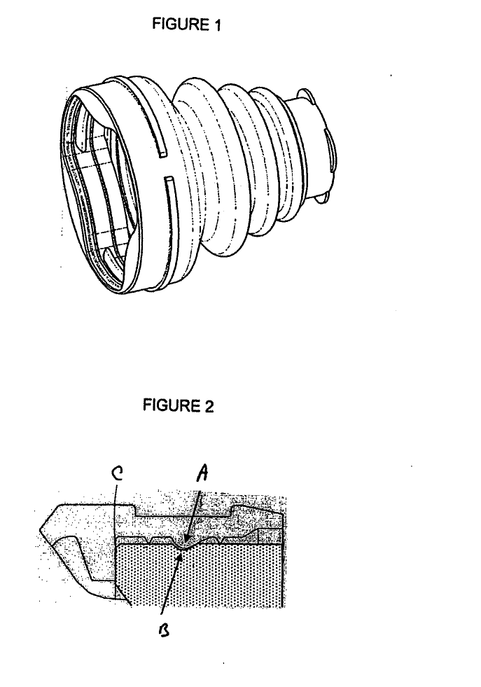

Such an assembly is well known to those versed in this technique and is described in particular in the European Patent EP-A-1,182,372. To date and as the prior art that is shown in FIGS. 1 and 2 illustrates, keeping the socket in position on the transmission bell is obtained, on the one hand, by a positioning stop, shown at C in FIG. 2, which makes it possible to constitute an end-of-travel stop during the introduction of the bell inside the socket, and, on the other hand, by a rim A that is designed to work with a groove B that is provided in the bell to prevent the bellows from detaching during various movements of the joint. This additional mechanical connection makes it necessary, on the one hand, to modify the periphery of the bell for providing said groove, on the other hand to provide, on the inside periphery of the large base of the socket, a holding rim. This double positioning involves reduced tolerances during production. To date, this solution has been adopted on the multilobed sockets due to the fact that the socket is also designed to limit the relative movement between the drive shaft and the bell. Consequently, the forces exerted on the socket are significant and the risks of detaching are high.

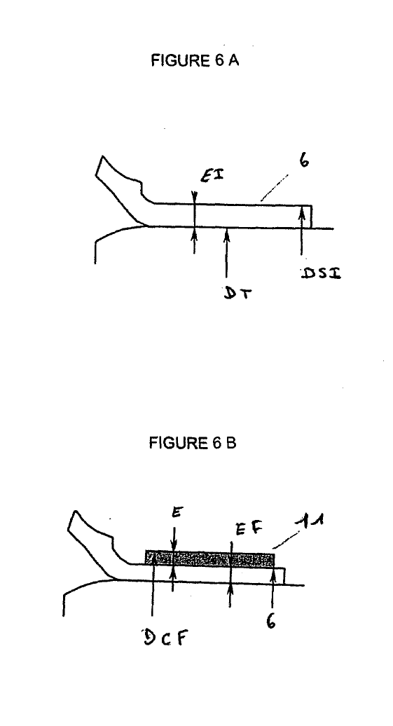

The Patent EP-A-1,450,060 confirms the necessity for the presence of axial immobilization means of the socket on the bell in the direction of slippage of a bell. Actually, this patent EP-A-1,450,060 describes a process for the production of a socket for protection of a vehicle transmission. The purpose on which the invention is based and which is described in this patent is to improve the sealing between the bellows shown at 60 or 100 in the figures and the bell shown under reference 80 in FIG. 7a. For this purpose, an inserted portion 56 is molded in the space that separates said bellows from said bell. As shown in FIG. 6 of this patent, the portion 56 has bulges over its surface designed to be in contact with the bell. These bulges can work with grooves provided in the bell. The FIG. 7A shows that the inserted portion, independently of its embodiment, is housed in a groove of the bell. The socket therefore comprises an undercut with its inserted portion. Thus, the solution that is described in this patent also comprises means of axial immobilization of the pressure area.

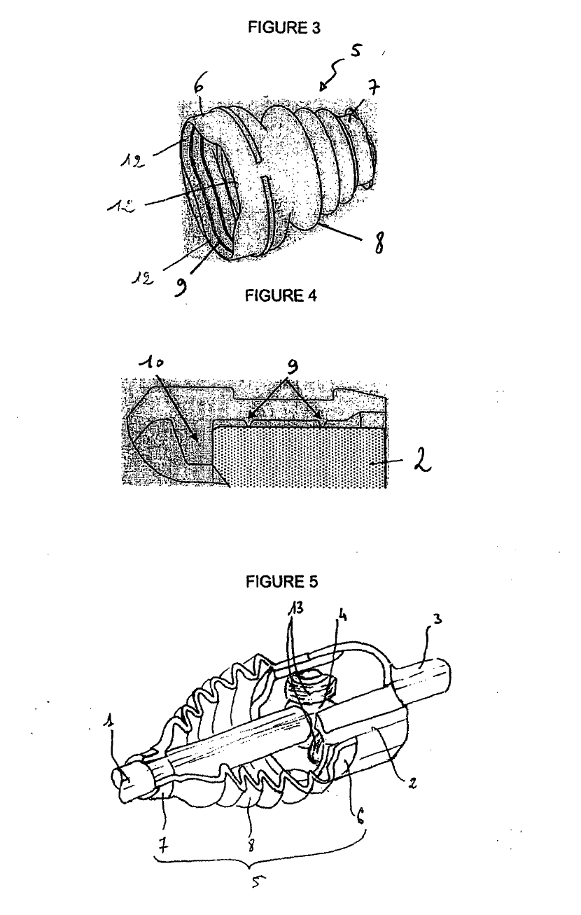

The document DE 102 53 059 describes a bellows that consists of two portions that are made integral with one another. One has the shape of a traditional bellows, in which the second portion, having a trilobed shape, is housed. The object of the invention is the assembly method used to makes these two portions integral, namely a laser weld. The means of holding the bellows around a shaft is not described in this document. Actually, none of the figures shows the device, object of the invention, in a situation with a shaft or a bell. In addition, FIGS. 2 and 3 do not show the internal surface of the assembly. Actually, whereby the bellows does not have a constant diameter, the grooves should be shown in the sections in FIGS. 2 and 3. Such is not the case because these figures are simplified diagrammatic embodiments. Consequently, such a document does not make it possible to make a conclusion regarding the design of the assembly method between bell and socket.

The inventors of this invention, however, were able to note that a simplification of the connection could be considered without impairing the holding of the socket on the bell during the operation or the handling of the transmission.

One object of this invention is therefore to propose a multilobed socket and a transmission joint incorporating such a socket whose designs allow a simplification of the socket and the bell used in receiving the socket without impairing the quality, in particular the sealing and the mechanical hold of the connection between bell and socket.

For this purpose, the invention has as its object a multilobed socket for protection of a vehicle transmission between a drive shaft and a transmission bell, whereby said socket comes in the form of a cylindrical-conical bellows that extends between the large multilobed base and the small socket base, characterized in that the socket has a new type of architecture close to the large multilobed base of said socket, whereby this architecture consists in eliminating, in the pressure area zone of the socket on the bell, any means of axial immobilization in said pressure area for the purpose of allowing free translation of the socket in the direction of slippage during a maintenance or replacement operation, whereby a tightening element, such as a collar or a ring, is provided on the external face of said pressure area to exert a radial pressure for immobilization of the socket against the receiving bell, whereby this radial pressure causes, to the right of the collar, a reduction of the thickness of the pressure area zone.

Thanks to the elimination of the holding rim at the bellows of the socket and the elimination of the machined groove at the bell, the relative positioning of the socket and the bell is simplified, as well as the production of elements.

According to a preferred embodiment of the invention, the final thickness of the socket in the zone of the smaller thickness, so-called non-lobed zone, to the right of the tightening element is at most equal to 85% of the initial thickness of the socket in said zone so as to ensure a mechanical hold and a sealing of the socket/bell connection.

The invention also has as its object a transmission joint of the type that comprises two shafts, an articulated transmission element that connects the two shafts, a multilobed socket that is designed to ensure the sealing of the joint and two tightening elements of the ends of the socket on a shaft or on an element of the joint that is integral with a shaft, whereby the two tightening elements are tightened on these ends, characterized in that the sealing socket is of the above-mentioned type.

The invention will be properly understood from reading the following description of embodiments, with reference to the accompanying drawings in which:

FIGS. 1 and 2 show, respectively, in the form of a perspective view and a cutaway view in the non-lobed zone, a socket in accordance with the prior art;

FIG. 3 shows a perspective view of a socket according to the invention;

FIG. 4 shows a cutaway view of the non-lobed zone for connection between socket and bell at the large multilobed base of the socket;

FIG. 5 shows a general outline of a transmission joint according to the invention in exploded position of the elements that constitute it, and

FIGS. 6A and 6B show, in partial diagrammatic form, the bellows and the bell in the non-lobed pressure area zone of the elements, whereby the parameters that make it possible to calculate the tightening value have been shown.

As mentioned above, the socket 5 is designed to protect a transmission of the type in accordance with the one that is shown in FIG. 5. The transmission joint thus comprises two shafts shown at 1 and 3 in the figures as well as an articulated transmission element 2, 4 that connects the two shafts 1, 3 to one another. This transmission element consists of a male element 4 that has three roller bearings spaced angularly by 120° from one another and a female element. The female element 2, also called a bell, has housings that each are designed to accommodate a roller 13. The male element of the joint is integral with the drive shaft that is shown at 1 in the figures while the female element or bell 2 of the joint is coupled to the shaft 3 that is obtained from the transmission. The socket is designed to protect this joint and is attached by its large multilobed base to the periphery of the bell 2, which constitutes the female element of the joint that is integral with the shaft 3, while its small base 7 is attached to the drive shaft 1 that is integral with the male element 4 of the joint. The bellows 8 of this socket therefore extends between the large multilobed base 6 and the small base 7 of said socket.

Quite obviously and in a manner that is known in the art, the large multilobed base 6 of the socket has an inside periphery of homothetic shape that is complementary to the external profile of the bell 2. Thus, this large base 6 has bulges on the inside in an arc designed to form the lobes of said socket. These lobes are connected to one another by a circular wall segment called a non-lobed zone 12 of the socket. The socket 5 with a general cylindrical-conical shape has, in its bellows zone 8, coils that develop from the small base 7 to the large base 6 of the socket. Large base 6 and small base 7 of the socket are designed, at their internal surface, to be tightened in an airtight way against the periphery of the associated element by an attachment element that can be of the collar 11 or ring type.

As mentioned above and in a manner that is characteristic of the invention, the pressure area zone of the socket 5 on the bell 2 is free of any axial immobilization means in the direction of slippage of the socket 5 from the bell 2.

In parallel, a tightening collar 11 is provided on the external face of the pressure area at the periphery of the large multilobed base 6 to exert a radial pressure of immobilization of the socket 5 against the receiving bell 2. The radial pressure that is exerted causes, to the right of the collar 11, a reduction of the thickness of the pressure area zone. This radial pressure should be adequate to ensure the sealing and the mechanical hold of the connection between socket and bell during the operation of the transmission. The tightening force to be applied, in the non-lobed zone 12, via the tightening collar 11 is therefore such that the final thickness of the socket 5 to the right of the tightening collar 11 is at most equal to 85% of the initial thickness of the socket in said zone so as to guarantee a mechanical hold and a sealing of the socket 5/bell 2 connection. The initial thickness of the socket, which bears the reference E1, corresponds to the outside diameter DSI of the large base of the socket mounted on the bell less the diameter DT of the bowl of the bell in the non-lobed zone 12, whereby the whole structure is divided by two. Thus, the initial thickness E1 corresponds to the following definition:

$$EI = \frac{DSI - DT}{2}$$

whereby DSI corresponds to the outside diameter of the large base of the socket and DT corresponds to the diameter of the bell in the non-lobed zone 12. The final thickness of the EF socket in the non-lobed zone 12 is equal to:

$$EF = \frac{DCF - DT}{2} - E in which$$

E corresponds to the thickness of the collar, DCF corresponds to the diameter of the collar, and DT corresponds to the diameter of the bell in the non-lobed zone 12. The tightening value expressed in percent is provided by the formula:

$$tightening = \frac{EI - EF}{EI}$$

It can also be expressed by the formula

$$tightening = \frac{1 - ( DCF - DT - 2 E )}{DSI - DT}$$

The tightening will therefore be done such that EF≦85%×EI.

In general, to ensure such a tightening force, the collar 11 or the ring is tightened on the socket 5.

To ensure adequate adhesion and a mechanical holding of the connection, it is also possible to vary the number of sealing lips 9 in parallel with the tightening value of the collar or the ring. Thus, the socket 5 has, in its pressure area zone on the inside periphery of the large multilobed base, at least one, preferably two sealing lips 9.

Finally, the large multilobed base 6 of the socket 5 delimits—in its transition zone with the bellows 8—an end-of-travel stop 10 against which the front surface of the bell 2 rests during the introduction of the latter into the socket. The function of the stop 10 is simply to mark how far the bell 2 slides into the socket 5.

1. Multilobed socket (5) for protection of a vehicle transmission between a drive shaft (1) and a transmission bell (2), whereby said socket (5) comes in the form of a cylindrical-conical bellows (8) that extends between the large multilobed base (6) and the small base (7) of the socket (5), characterized in that the socket has a new type of architecture close to the large multilobed base (6) of said socket (5), whereby this architecture consists in eliminating, in the pressure area zone of the socket (5) on the bell (2), any means of axial immobilization in said pressure area for the purpose of allowing free translation of the socket (5) in the direction of slippage during a maintenance or replacement operation, whereby a tightening element (11), such as a collar or a ring for tightening, is provided on the external face of said pressure area to exert a radial pressure for immobilization of the socket (5) against the receiving bell (2), whereby this radial pressure causes, to the right of the collar (11), a reduction of the thickness of the pressure area zone.

2. Socket (5) according to claim 1, wherein the final thickness of the socket (5), in the zone (12) of lesser thickness, so-called non-lobed zone, to the right of the tightening element (11), is at most equal to 85% of the initial thickness of the socket (5) in said zone so as to ensure a mechanical hold and a sealing of the socket (5)/bell (2) connection.

3. Socket (5) according to claim 1, wherein the tightening element (11), such as a collar or ring, is tightened on the socket (5).

4. Socket (5) according to claim 1, wherein it has at least one, preferably two, sealing lips (9) in its pressure area zone, on the inside periphery of the large multilobed base (6).

5. Socket (5) according to claim 1, wherein in its transition zone with the bellows (8), the large multilobed base (6) of the socket (5) delimits an end-of-travel stop (10) against which the front surface of the bell (2) rests during the introduction of the latter into the socket (5).

6. Transmission joint of the type that comprises two shafts (1, 3), an articulated transmission element (2, 4) that connects the two shafts (1, 3), a multilobed socket (5) that is designed to ensure the sealing of the joint and two elements (11) for tightening the ends of the socket (5) on a shaft (1) or on an element (2) of the joint that is integral with a shaft (3), whereby the two tightening elements (11) are tightened on these ends, wherein the sealing socket (5) is in accordance with claim 1.

7. Socket (5) according to claim 2, wherein the tightening element (11), such as a collar or ring, is tightened on the socket (5).

8. Socket (5) according to claim 2, wherein it has at least one, preferably two, sealing lips (9) in its pressure area zone, on the inside periphery of the large multilobed base (6).

9. Socket (5) according to claim 3, wherein it has at least one, preferably two, sealing lips (9) in its pressure area zone, on the inside periphery of the large multilobed base (6).

10. Socket (5) according to claim 2, wherein in its transition zone with the bellows (8), the large multilobed base (6) of the socket (5) delimits an end-of-travel stop (10) against which the front surface of the bell (2) rests during the introduction of the latter into the socket (5).

11. Socket (5) according to claim 3, wherein in its transition zone with the bellows (8), the large multilobed base (6) of the socket (5) delimits an end-of-travel stop (10) against which the front surface of the bell (2) rests during the introduction of the latter into the socket (5).

12. Socket (5) according to claim 4, wherein in its transition zone with the bellows (8), the large multilobed base (6) of the socket (5) delimits an end-of-travel stop (10) against which the front surface of the bell (2) rests during the introduction of the latter into the socket (5).

13. Transmission joint of the type that comprises two shafts (1, 3), an articulated transmission element (2, 4) that connects the two shafts (1, 3), a multilobed socket (5) that is designed to ensure the sealing of the joint and two elements (11) for tightening the ends of the socket (5) on a shaft (1) or on an element (2) of the joint that is integral with a shaft (3), whereby the two tightening elements (11) are tightened on these ends, wherein the sealing socket (5) is in accordance with claim 2.

14. Transmission joint of the type that comprises two shafts (1, 3), an articulated transmission element (2, 4) that connects the two shafts (1, 3), a multilobed socket (5) that is designed to ensure the sealing of the joint and two elements (11) for tightening the ends of the socket (5) on a shaft (1) or on an element (2) of the joint that is integral with a shaft (3), whereby the two tightening elements (11) are tightened on these ends, wherein the sealing socket (5) is in accordance with claim 3.

15. Transmission joint of the type that comprises two shafts (1, 3), an articulated transmission element (2, 4) that connects the two shafts (1, 3), a multilobed socket (5) that is designed to ensure the sealing of the joint and two elements (11) for tightening the ends of the socket (5) on a shaft (1) or on an element (2) of the joint that is integral with a shaft (3), whereby the two tightening elements (11) are tightened on these ends, wherein the sealing socket (5) is in accordance with claim 4.

16. Transmission joint of the type that comprises two shafts (1, 3), an articulated transmission element (2, 4) that connects the two shafts (1, 3), a multilobed socket (5) that is designed to ensure the sealing of the joint and two elements (11) for tightening the ends of the socket (5) on a shaft (1) or on an element (2) of the joint that is integral with a shaft (3), whereby the two tightening elements (11) are tightened on these ends, wherein the sealing socket (5) is in accordance with claim 5.
